(19) United States
(12) Patent Application Publication
(10) Pub. No.: US 2026/0233647 A1
(43) Pub. Date: Aug. 13, 2026

(54) CUSHION BODY

(71) Applicant: TOYOTA BOSHOKU KABUSHIKI KAISHA, Aichi-ken (JP)

(72) Inventor: Masahiko IYODA, Aichi-ken (JP)

(73) Assignee: TOYOTA BOSHOKU KABUSHIKI KAISHA, Aichi-ken (JP)

(21) Appl. No.: 19/454,757

(22) Filed: Jan. 21, 2026

(30) Foreign Application Priority Data
Feb. 10, 2025 (JP) 2025-019918

(51) Int. Cl. B60N 2/56; B60N 2/58

(52) U.S. Cl. CPC B60N 2/5685; B60N 2/5825

(57) ABSTRACT

A cushion body elastically supports a seater and is divided into three components: a central main portion and two adjacent side portions. The central main portion includes a seat pad, a substrate on the rear surface of the seat pad, a seat cover that covers the seat pad from the seat front side and has its terminal portion fixed to the substrate, and a seat heater disposed between the seat cover and the seat pad. The seat cover has a suspension portion that is suspended from the substrate through a through-hole formed in the seat pad. The substrate has a bypass hole directly facing the suspension portion, allowing a bent-back bypass portion of the seat heater to pass through and bypass the suspension portion.

### CROSS-REFERENCE TO RELATED APPLICATION

This application claims priority to Japanese patent application serial number 2025- 19918 filed February 10, 2025, the contents of which are incorporated herein by reference in its entirety for all purposes.

### TECHNICAL FIELD

The present disclosure relates to a cushion body, particularly one that elastically supports a seater.

### BACKGROUND

Conventionally, a seat has been known which includes a cushion body comprising a seat pad and a seat cover that covers the seat pad. The seat is divided into three parts in a seat width direction. Specifically, the cushion body comprises a main portion that is the central portion in the seat width direction, and two side portions that are side portions of the main portion in the seat width direction.

The main portion and the two side portions are each covered with seat covers that enclose the seat pads. Each terminal of the seat cover is attached to a resin base substrate located on the rear side of the seat pads. Therefore, the main and side portions are configured such that each seat pad is sandwiched between the seat cover and the substrate.

The main portion is secured by suspending various parts of the seat cover to the substrate through through-holes formed in the seat pad. Specifically, a resin suspender attached to the edge of a suspension cloth sewn onto the seat cover is snap-fitted into a clip mounted on the substrate by being pushed into it.

In conventional configurations, when a flat seat heater is placed between a seat cover and a seat pad, there is a risk that the seat heater may be pressed against the substrate by the suspenders on the back side of the seat cover's suspension portion. Therefore, the present disclosure provides a cushion body that enables appropriate positioning of the seat heater.

### SUMMARY

In order to solve the above problem, the present disclosure has the following configuration.

A cushion body that elastically supports a seater, wherein the cushion body is divided into three elements; a main portion and two side portions that are a side portion of the main portion in a seat width direction. The main portion comprises a seat pad, a substrate provided on the rear surface of the seat pad, a seat cover that covers the seat pad from the seat front side and has its terminal portion fixed to the substrate, and a seat heater disposed between the seat cover and the seat pad. The seat cover has a suspension portion that is suspended from the substrate through a through-hole formed in the seat pad. The substrate has a bypass hole at a position facing the suspension portion, through which a bypass portion of the seat heater, bent back toward the rear side of the seat to bypass the suspension portion, can pass.

### BRIEF DESCRIPTION OF DRAWINGS

FIG. 1 is a perspective view showing a schematic configuration of a cushion body according to a first embodiment.

FIG. 2 is an exploded perspective view of the cushion body removed from a back frame.

FIG. 3 is an exploded perspective view showing a main portion separated from a substrate.

FIG. 4 is a cross-sectional view of the main portion taken along a line IV-IV in FIG. 3.

FIG. 5 is a cross-sectional view of the main portion taken along a line V-V in FIG. 3.

### DETAILED DESCRIPTION

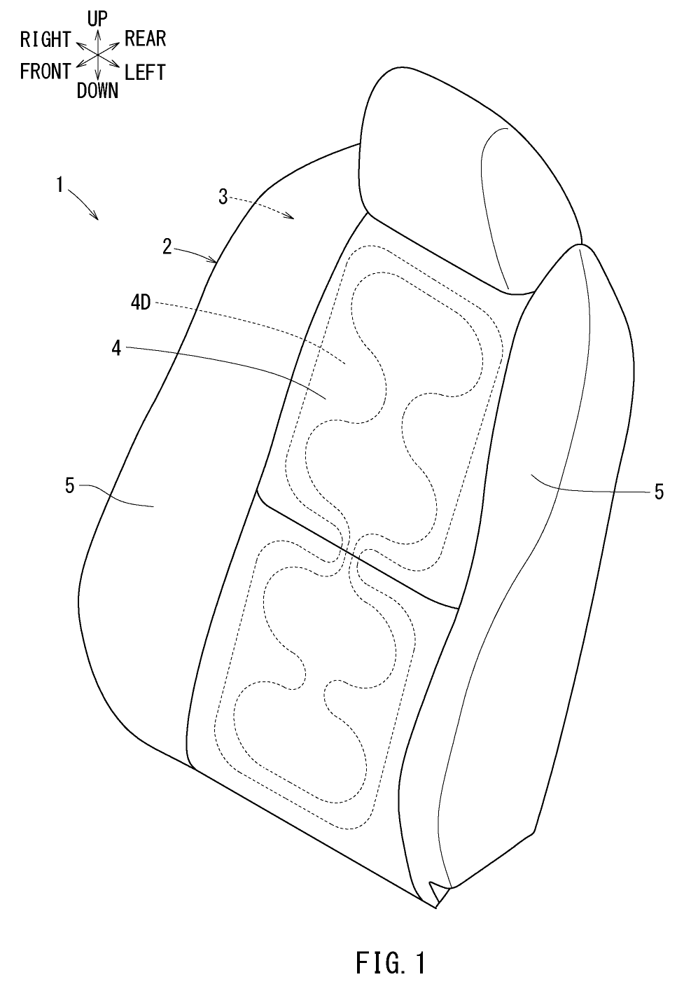

First, the configuration of a cushion body 2 according to a first embodiment of the present disclosure will be described with reference to FIGS. 1 to 5. In the following description, when directions such as front, rear, up, down, right, and left are indicated, these refer to the respective directions shown in each figure.

Furthermore, directions indicated with "seat" attached to each direction such as "seat width direction," they refer to directions based on a seat back 1 described later. In addition, in the following description, when a specific reference drawing is not shown or when there is no reference numeral corresponding to the reference drawing, any one of FIGS. 1 to 5 shall be referred to as appropriate.

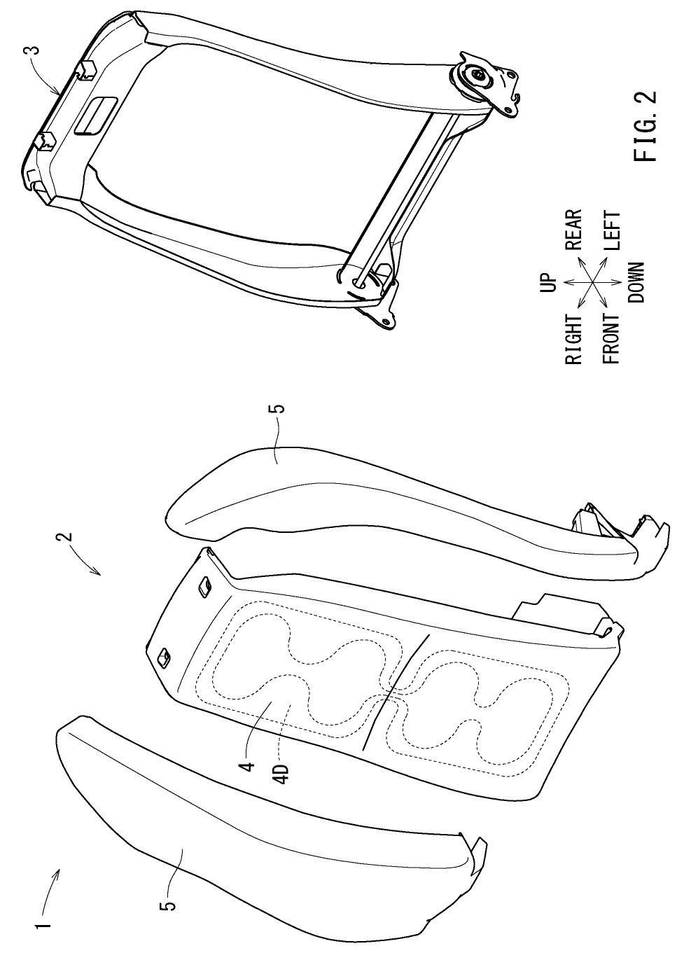

As shown in FIG. 1, the cushion body 2 according to the present embodiment is applied to the seat back 1 that forms a backrest portion of an automotive seat. As shown in FIG. 2, the seat back 1 has the cushion body 2 that elastically supports the back of a seater and a back frame 3 that supports the cushion body 2 from the back side of the seat.

The cushion body 2 is configured to be divided into three elements: a main portion 4 that forms a central portion in a seat width direction, and two side portions 5 that form both side portions in the seat width direction. The back frame 3 is made of a metal member assembled in a frame shape when viewed from the front.

Since the cushion body 2 is divided into the main portion 4 and each side portion 5 as described above, parts can be replaced according to specifications for each divided portion. The main portion 4 and each side portion 5 are individually assembled to the back frame 3 after assembling the respective component parts into one unit for each divided portion.

Specifically, each side portion 5 is integrally fixed to the back frame 3 by fitting with clips (not shown) or fastening with bolts. The main portion 4 is set so as to be fitted between them from the front of the seat after each side portion 5 is assembled to the back frame 3. Specifically, the main portion 4 is fixed such that its upper and lower portions are hooked to the upper and lower portions of the back frame 3.

The main portion 4 and each side portion 5 have a common basic structure, except for the presence or absence of a seat heater 4D, which will be described later. The configuration of each divided element of the cushion body 2 will be described in detail below, using the main portion 4 as an example.

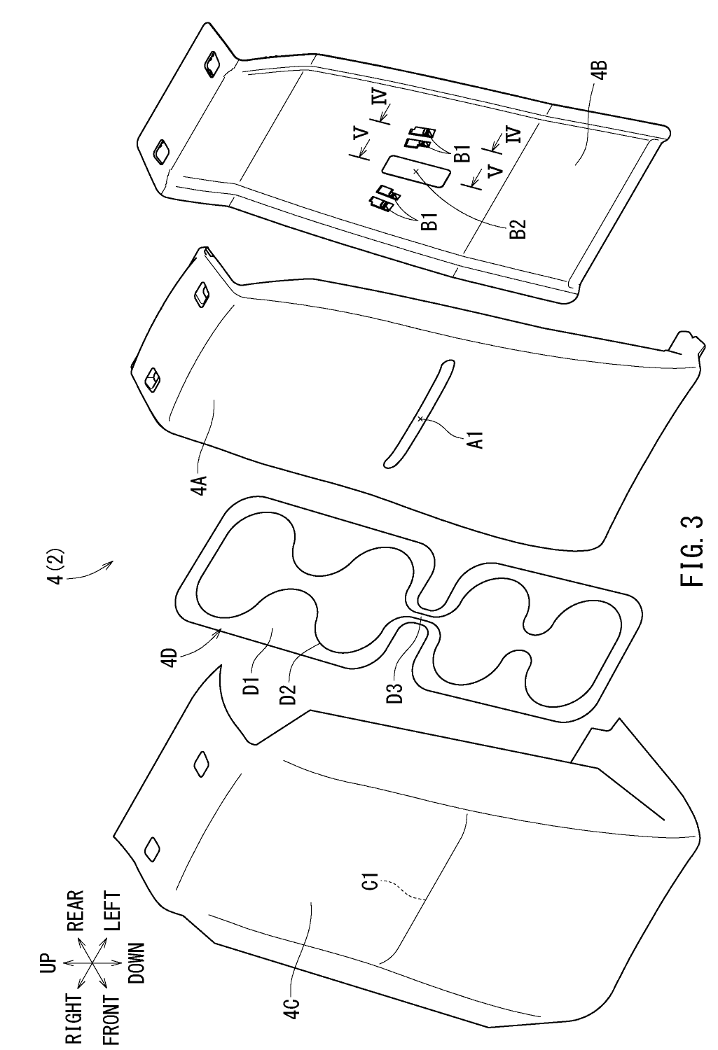

As shown in FIG. 3, the main portion 4 includes a seat pad 4A, which is made of foamed urethane, and a resin substrate 4B, which is disposed on the rear surface of the seat pad 4A. Furthermore, the main portion 4 has a fabric seat cover 4C that covers the seat pad 4A from the front side.

The main portion 4 also includes a seat heater 4D arranged between the seat cover 4C and the seat pad 4A. The seat heater 4D includes a non-woven heater base fabric D1 and a heater wire D2 arranged in a wavy pattern along the surface of the heater base fabric D1.

The heater wire D2 is fixed to the heater base fabric D1 at various points. The seat heater 4D has a known heater structure in which the heater wire D2 generates heat when powered by electricity supplied from an external source, thereby providing warmth to the seated occupant.

The seat cover 4C has its peripheral edge portion (cover terminal) drawn toward and secured to the rear surface of the substrate 4B. This causes the seat cover 4C to sandwich the seat heater 4D between itself and the seat pad 4A, and wraps around the seat pad 4A in cooperation with the substrate 4B, thereby forming a single module integrated with the substrate 4B. Consequently, the main portion 4 is assembled as a single module.

The main portion 4 is integrally fixed by having the substrate 4B, provided on its rear surface, fitted onto the upper frame portion of the back frame 3 shown in FIG. 2 from above the seat. Furthermore, the main portion 4 is integrally fixed by having the lower cover end of its seat cover 4C pulled in from below and hooked onto the lower frame portion of the back frame 3 from below, towards the rear side of the seat.

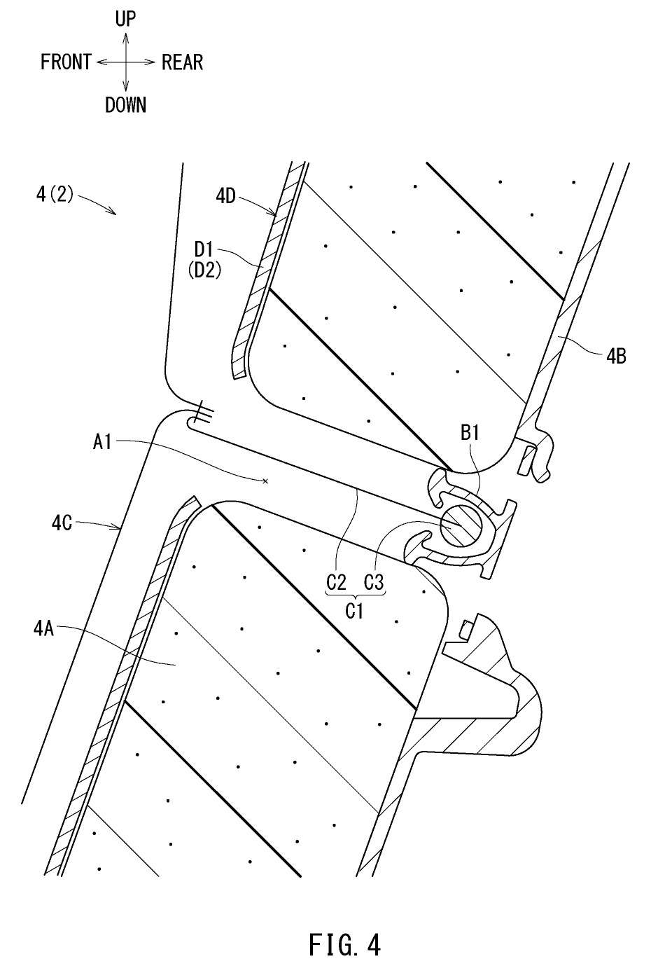

As shown in FIG. 3, four resin clips B1 are attached to the substrate 4B at its mid- height position. Each clip B1 is arranged in a horizontal row on the surface of the substrate 4B. As shown in FIG. 4, each clip B1 serves as a fastener for securing a suspension portion C1, which is pulled through a through-hole Al of the seat pad 4A from the seat cover 4C, to the substrate 4B.

The suspension portion C1 is provided to extend in the seat width direction along the seam of the upper and lower pieces of the seat cover 4C . The suspension portion C1 comprises a belt-shaped suspension cloth C2 sewn along the suspension portion C1 of the seat cover 4C, and a resin-made suspender C3 integrally molded along the terminal of the suspension cloth C2. The suspension cloth C2 is made of a cloth-like material such as nonwoven fabric or fabric. The suspender C3 is made of a material harder than the suspension cotton cloth C2.

The suspension portion C1 is configured to extend uniformly across substantially the entire sewing area of the seat cover 4C so that a uniform suspension force can be applied to the sewing area. As shown in FIG. 3, the through-hole A1 in the seat pad 4A is formed to extend horizontally in the seat width direction so that the suspension portion C1 be passed straight through from the front side to the rear side of the seat.

As shown in FIG. 4, the suspension portion C1 is inserted through the through-hole A1 formed in the seat pad 4A and pushed into each clip B1 provided on the substrate 4B, whereby the suspender C3 to snap-fit to each clip B1. Therefore, the sewn portion of the seat cover 4C is held in a suspended state on the substrate 4B via the suspension portion C1.

As shown in FIG. 3, a bypass hole B2, formed as a vertically elongated rectangular hole shape, is provided between the two clips B1 at the center-side of the substrate 4B. The bypass hole B2 is arranged in a horizontal row aligned with each clip B1.

The bypass hole B2 serves as a hole to prevent the seat heater 4D from being sandwiched between the suspension portion C1 and the substrate 4B when the suspension portion C1 is pressed into each clip B1. Here, the two middle clips B1 sandwiching the bypass hole B2 correspond to the "fixing portion" of the present disclosure.

Specifically, the seat heater 4D is disposed such that it lies on both the upper and lower surfaces of the seat pad 4A, above and below the through-hole A1. The heater base fabric D1 has a bypass portion D3 formed in a vertically intermediate region thereof, which is laid across the through-hole A1 of the seat pad 4A. The bypass portion D3 is shaped with narrowed sides to allow it to pass through the hole without interfering with surrounding components.

The bypass portion D3 is formed with a narrowed shape so as to fit within the width of the bypass hole B2 provided in the substrate 4B. The heater wire D2 is arranged to extend onto both the upper and lower surfaces of the seat pad 4A by bypassing the suspension via the bypass portion D3, in accordance with the shape of the heater base fabric D1.

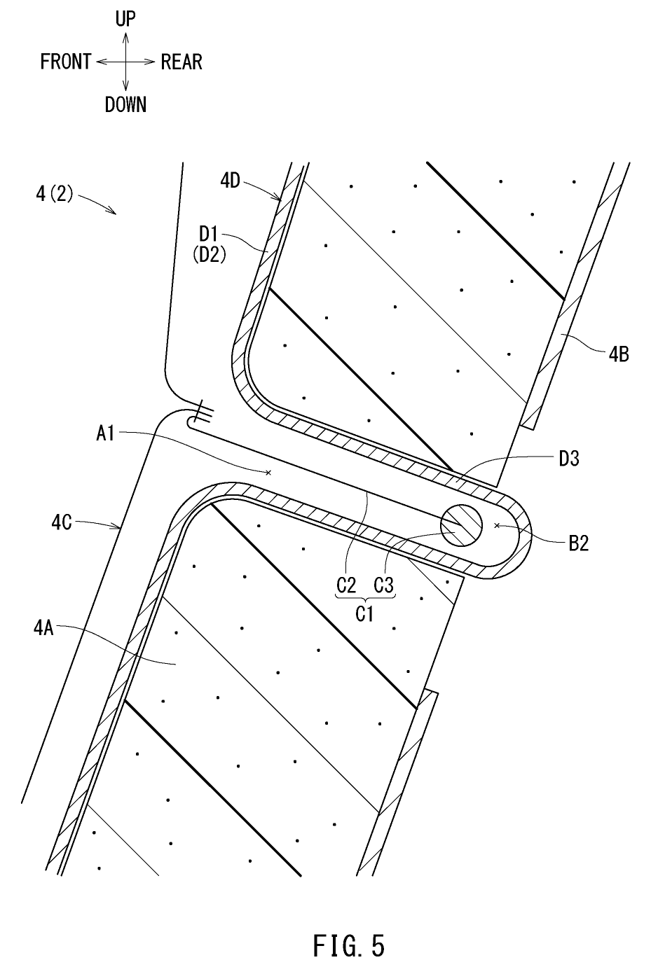

The seat heater 4D is set onto the surface of the seat pad 4A as follows. First, as shown in FIG. 5, the bypass portion D3 of the seat heater 4D is set by pushing it through the through-hole A1 of the seat pad 4A into the bypass hole B2 of the substrate 4B. This causes the bypass portion D3 to be positioned such that it is bent back in a U-shape through the through-hole Al of the seat pad 4A to the underside of the seat.

Next, as shown in FIG. 4, when the seat cover 4C is positioned over the seat pad 4A, the suspension portion C1 is suspended from the through-hole A1 of the seat pad 4A and inserted into each clip B1 of the substrate 4B. Therefore, as shown in FIG. 5, the suspender C3 of the suspension portion C1 is pushed near the substrate 4B. However, because the bypass portion D3 of the seat heater 4D is already passed through the bypass hole B2 of the substrate 4B, the suspender C3 of the suspension portion C1 is prevented from being pressed against the bypass portion D3.

Therefore, even if the suspender C3 of the suspension portion C1 is pressed against the substrate 4B due to the application of a seating load, the bypass portion D3 of the set heater 4D will not become pinched between the suspender C3 and the substrate 4B. Accordingly, excessive load is prevented from being applied to the seat heater 4D.

In summary, the cushion body 2 according to the embodiment has the following configuration. The reference numerals in parentheses correspond to those used in the above embodiment.

Specifically, a cushion body (2) that elastically supports a seater is divided into three separate elements; a main portion (4) and two side portions (5) that is a side portion of the main portion in a seat width direction. The main portion (4) comprises a seat pad (4A), a substrate (4B) provided on the rear surface of the seat pad (4A), and a seat cover (4C) that covers the seat pad (4A) from the seat front side and has its terminal portion fixed to the substrate (4).

The main portion (4) also has a planar a seat heater (4D) that is disposed between the seat cover (4C) and the seat pad (4A). The seat cover (4C) has a suspension portion (C1) that is suspended from the substrate (4B) through a through-hole (A1) formed in the seat pad (4A). The substrate (4B) has a bypass hole (B2) at a position facing the suspension portion (C1), through which a bypass portion (D3) of the seat heater (4D), bent back toward the rear side of the seat to bypass the suspension portion (C1), can pass.

Accordingly, even if the suspender (C3) of the suspension portion (C1) is pressed against the substrate (4B) due to the insertion of the suspension portion (C1) or the application of a seating load, the bypass portion (D3) of the seat heater (4D) is prevented from being pressed against the substrate (4B). This allows the seat heater (4D) to be appropriately positioned so as to avoid excessive load being applied thereto.

Furthermore, the substrate (4B) has fixing portions (B1) at two positions along the suspension portion (C1) to secure the suspension portion (C1). The bypass hole (B2) is formed at a position between the two fixing portions (B1). Accordingly, even if the bypass portion (D3) of the seat heater (4D) is positioned between the two locations where the suspension portion (C1) is fixed, excessive load on the bypass portion (D3) can be prevented.

Although the present disclosure has been described using one embodiment, the present disclosure can be implemented in various forms other than the above-described embodiment.

The cushion body of the present disclosure can also be applied to seats in non- automotive vehicles such as railways, aircraft, and ships. Furthermore, the cushion body can be applied to non-vehicle seats installed in various facilities such as sports facilities, theaters, concert halls, and event venues. Additionally, the cushion body can be applied to seat structures other than seatbacks, such as seat cushions, headrests, ottomans, and armrests.

The seat cover may be made of fabric as well as leather material. The suspension portion of the seat cover may be configured to be fixed to the fixing portion of the substrate by a hog ring. The fixing portion of the substrate may be configured according to the fixing method of the suspension portion.

The various examples described above in detail with reference to the attached drawings are intended to be representative of the present disclosure and are thus non-limiting embodiments. The detailed description is intended to teach a person of skill in the art to make, use and/or practice various aspects of the present teachings, and thus does not limit the scope of the disclosure in any manner. Furthermore, each of the additional features and teachings disclosed above may be applied and/or used separately or with other features and teachings in any combination thereof, to provide an improved cushion body and/or methods of making and using the same.

What is claimed is:

1. A cushion body configured to elastically support a seated occupant, the cushion body being divided into three divided elements including a main portion forming a central portion in a seat width direction and two side portions forming respective side portions in the seat width direction,
wherein the main portion comprises:
a seat pad;
a substrate provided on a rear surface of the seat pad;
a seat cover that covers the seat pad from a seat front side and has a cover terminal portion fixed to the substrate;
a planar seat heater disposed between the seat cover and the seat pad; and
a planar suspension portion of the seat cover configured to be hooked to the substrate through a through-hole formed in the seat pad;
and wherein the substrate has a bypass hole formed at a position facing the suspension portion, through which the bypass portion of the seat heater, which is bent back toward the rear of the seat so as to bypass the suspension portion, can pass.

2. The cushion body according to claim 1,
wherein the substrate comprises two fixing portions arranged along the suspension portion to secure the suspension portion,
and wherein the bypass hole is formed between the two fixing portions.

3. The cushion body according to claim 2, wherein the two fixing portions are clips attached to the substrate at a mid-high position.

4. The cushion body of claim 3, wherein the clips are arranged in a horizontal row on a surface of the substrate.

5. The cushion body according to claim 1, wherein the suspension portion includes a suspender configured to snap-fit into the clips.

6. The cushion body according to claim 1, wherein the seat heater further comprises a non-woven heater base fabric and a heater wire arranged in a wavy pattern along the surface of the heater base fabric, and wherein the heater wire is arranged to extend onto both the upper and lower surfaces of the seat pad by passing through the bypass portion.
